(19) United States
(12) Patent Application Publication
(10) Pub. No.: US 2004/0128476 A1
(43) Pub. Date: Jul. 1, 2004

(54) Scheme to simplify instruction buffer logic supporting multiple strands

(76) Inventors: Robert Nuckolls, Santa Clara, CA (US); Sorin Iacobovici, San Jose, CA (US); Rabin A. Sugumar, Sunnyvale, CA (US); Chandra M. R. Thimmannagari, Fremont, CA (US)

Correspondence Address: OSHA & MAY L.L.P./SUN, 1221 MCKINNEY, SUITE 2800, HOUSTON, TX, 77010, US

(21) Appl. No.: 10/329,856

(22) Filed: Dec. 26, 2002

(51) Int. Cl. G06F 9/30

(52) U.S. Cl. 712/206; 712/215

(57) ABSTRACT

A method and apparatus for processing instructions involves an instruction fetch unit arranged to receive a plurality of instructions. The instruction fetch unit includes a bypass buffer arranged to receive at least a portion of a plurality of instructions, and an output multiplexer arranged to receive the at least a portion of the plurality of instructions where the output multiplexer is arranged to output an instruction selected from one of an output of the bypass buffer and the at least a portion of the plurality of instructions.

### BACKGROUND OF INVENTION

As shown in FIG. 1, a computer (24) includes a processor (26), memory (28), a storage device (30), and numerous other elements and functionalities found in computers. The computer (24) may also include input means, such as a keyboard (32) and a mouse (34), and output means, such as a monitor (36). Those skilled in the art will appreciate that these input and output means may take other forms.

The processor (26) may be required to process multiple processes. The processor (26) may operate in a batch mode such that one process is completed before the next process is run. Some processes may incur long latencies such that no useful work is performed by the processor (26) during the long latencies. A processor (26) that is arranged to process two or more processes, or strands, may be able to switch to another strand when a long latency event occurs.

The processor (26) may include several register files and maintain several program counters. Each register file and program counter holds a program state for a separate strand. When a long latency event occurs, such as a cache miss, the processor (26) switches to another strand. The processor (26) executes instructions from another strand while the cache miss is being handled.

The processor (26) may include a fetch unit and a decode unit as part of a pipeline. An instruction from a first strand is fetched by the fetch unit and forwarded to the decode unit. The decode unit determines whether sufficient resources are available to proceed with processing the instruction from the first strand. If insufficient resources are available, the decode unit may request an instruction from a second strand from the fetch unit. Accordingly, an instruction from a second strand is forwarded to the decode unit by the fetch unit. In the process, the instruction from the first strand has already been forwarded by the fetch unit and is no longer stored in the fetch unit. The fetch unit and decode unit may incur a latency to refetch the instruction from the first strand.

### SUMMARY OF INVENTION

According to one aspect of the present invention, an apparatus comprising an instruction fetch unit arranged to receive a plurality of instructions, the instruction fetch unit comprising a first bypass buffer arranged to receive at least a first portion of the plurality of instructions, and an output multiplexer arranged to receive the at least a first portion of the plurality of instructions where the output multiplexer is arranged to output an instruction selected from one of an output of the first bypass buffer and the at least a first portion of the plurality of instructions; a decode unit operatively connected to the instruction fetch unit and arranged to decode the instruction; and an execution unit operatively connected to the decode unit and arranged to process data dependent on the instruction.

According to one aspect of the present invention, a method for processing a plurality of instructions comprising propagating at least a first portion of the plurality of instructions; buffering the at least a first portion of the plurality of instructions; selectively propagating an instruction selected from one of an output of the first bypass buffer and the at least a first portion of the plurality of instructions; decoding the instruction; and executing the instruction.

According to one aspect of the present invention, a method to process instructions comprising fetching a first strand where the first strand comprises instructions from a first process; fetching a second strand where the second strand comprises instructions from a second process; and selectively switching from the first strand to the second strand dependent on whether an instruction refetch for the second strand has occurred.

According to one aspect of the present invention, an apparatus comprising means for propagating at least a first portion of a plurality of instructions; means for propagating at least a second portion of the plurality of instructions; means for buffering the at least a first portion of the plurality of instructions where the means for buffering outputs a buffered first portion of the plurality of instructions; means for buffering the at least a second portion of the plurality of instructions where the means for buffering outputs a buffered second portion of the plurality of instructions; and means for selectively propagating an instruction selected from one of the at least a first portion of the plurality of instructions, the at least a second portion of the plurality of instructions, the buffered first portion of the plurality of instructions, and the buffered second portion of the plurality of instructions.

Other aspects and advantages of the invention will be apparent from the following description and the appended claims.

### BRIEF DESCRIPTION OF DRAWINGS

FIG. 1 shows a block diagram of a typical computer system.

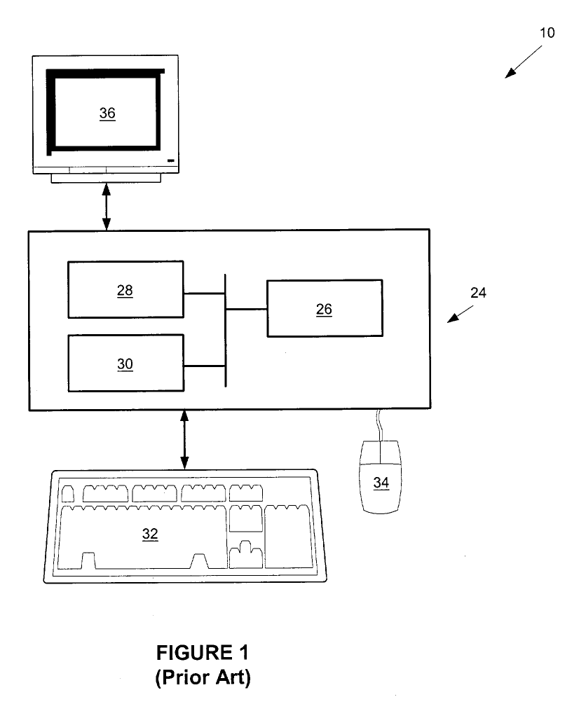

FIG. 2 shows a block diagram of a computer system pipeline in accordance with an embodiment of the present invention.

FIG. 3 shows a block diagram of a fetch unit in accordance with an embodiment of the present invention.

FIG. 4 shows a flow diagram of a strand switching algorithm in accordance with an embodiment of the present invention.

FIG. 5 shows a strand switching pipeline diagram in accordance with an embodiment of the present invention.

### DETAILED DESCRIPTION

Embodiments of the present invention relate to an apparatus and method for buffering an instruction such that the instruction is readily available if an instruction refetch occurs. The method and apparatus uses one or more bypass buffers to temporarily store instructions. A multiplexer may be arranged to select between an instruction and a instruction from the bypass buffer.

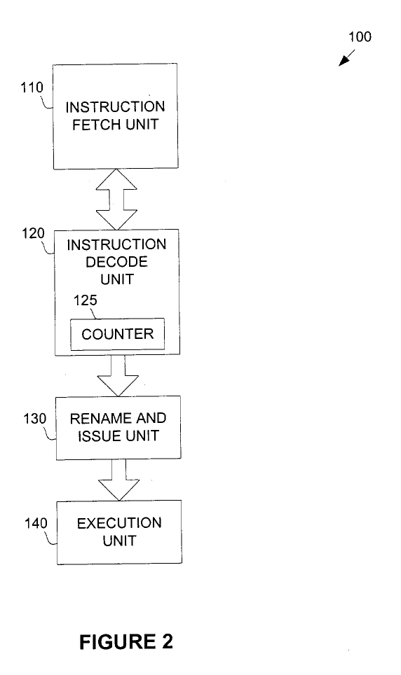

FIG. 2 shows a block diagram of an exemplary computer system pipeline (100) in accordance with an embodiment of the present invention. The computer system pipeline (100) includes an instruction fetch unit (110), an instruction decode unit (120), a rename and issue unit (130), and an execution unit (140). Not all functional units are shown in the computer system pipeline (100), e.g., a data cache unit. Any of the units (110, 120, 130, 140) may be pipelined or include more than one stage. Accordingly, any of the units (110, 120, 130, 140) may take longer than one cycle to complete a process.

The instruction fetch unit (110) is responsible for fetching instructions from memory (not shown). Accordingly, instructions may not be readily available, i.e., a miss occurs. The instruction fetch unit (110) performs actions to fetch the proper instructions.

The instruction fetch unit (110) allows two instruction strands to be running in the instruction fetch unit (110) at any time. Only one strand, however, may actually be fetching instructions at any time. At least two buffers are maintained to support the two strands. The instruction fetch unit (110) fetches bundles of instructions. In one embodiment of the present invention, up to three instructions may be included in each bundle.

In one embodiment, the instruction decode unit (120) is divided into two decode stages (D1, D2). D1 and D2 are each responsible for partial decoding of an instruction. D1 may also flatten register fields, manage resources, kill delay slots, determine strand switching, and determine the existence of a front end stall. Flattening a register field maps a smaller number of register bits to a larger number of register bits that maintain the identity of the smaller number of register bits and additional information such as a particular architectural register file. A front end stall may occur if an instruction is complex, requires serialization, is a window management instruction, results in a hardware spill/fill, has an evil twin condition, or a control transfer instruction, i.e., has a branch in a delay slot of another branch.

A complex instruction is an instruction not directly supported by hardware and may require the complex instruction to be broken into a plurality of instructions supported by hardware. An evil twin condition may occur when executing a fetch group that contains both single and double precision floating point instructions. A register may function as both a source register of the single precision floating point instruction and as a destination register of a double precision floating point instruction, or vice versa. The dual use of the register may result in an improper execution of a subsequent floating point instruction if a preceding floating point instruction has not fully executed, i.e., committed the results of the computation to an architectural register file.

The instruction decode unit (120) may include a counter (125) that is responsible for tracking a number of clock cycles or a number of time intervals. The counter (125) may indicate when a strand switch is desirable.

The rename and issue unit (130) is responsible for renaming, picking, and issuing instructions. Renaming takes flattened instruction source registers provided by the instruction decode unit (120) and renames the flattened instruction source registers to working registers. Renaming may start in the instruction decode unit (120). Also, the renaming determines whether the flattened instruction source registers should be read from an architectural or working register file.

Picking monitors an operand ready status of an instruction in an issue queue, performs arbitration among instructions that are ready, and selects which instructions are issued to execution units. The rename and issue unit (130) may issue one or more instructions dependent on a number of execution units and an availability of an execution unit. The computer system pipeline (100) may be arranged to simultaneously process multiple instructions.

Issuing instructions steers instructions selected by the picking to an appropriate execution unit.

The execution unit (140) is responsible for executing the instructions issued by the rename and issue unit (130). The execution unit (140) may include multiple functional units such that multiple instructions may be executed simultaneously.

In FIG. 2, each of the units (110, 120, 130, 140) provides processes to load, break down, and execute instructions. Resources are required to perform the processes. In an embodiment of the present invention, resources are any queue that may be required to process an instruction. For example, the queues include a live instruction table, issue queue, integer working register file, floating point working register file, condition code working register file, load queue, store queue, and branch queue. As some resources may not be available at all times, some instructions may be stalled. Furthermore, because some instructions may take more cycles to complete than other instructions, or resources may not currently be available to process one or more of the instructions, other instructions may be stalled. A lack of resources may cause a resource stall. Instruction dependency may also cause some stalls. Accordingly, switching strands may allow some instructions to be processed by the units (110, 120, 130, 140) that may not otherwise have been processed at that time.

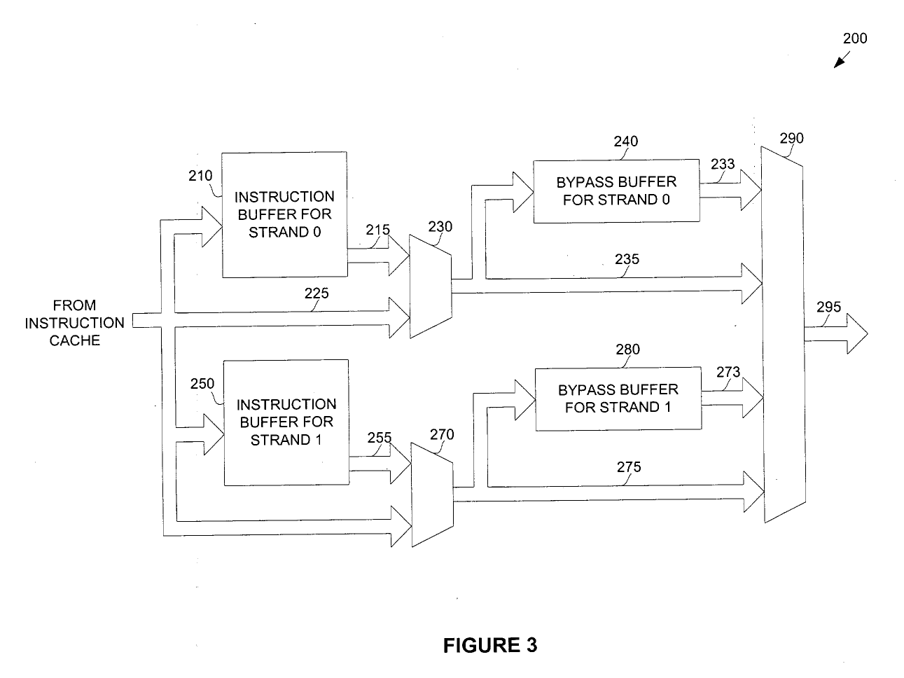

FIG. 3 shows a block diagram of an exemplary fetch unit (200) in accordance with an embodiment of the present invention. The fetch unit (200) supports two strands. One of ordinary skill in the art will understand that a plurality of strands may be supported. Furthermore, single instructions for each strand and/or bundles of instructions that include a plurality of instructions for each strand may be handled by the fetch unit (200).

The fetch unit (200) includes duplicate elements to support the two strands.

For example, an instruction buffer (210), a multiplexer (230), and a bypass buffer (240) are included to support strand 0. Similarly, an instruction buffer (250), a multiplexer (270), and a bypass buffer (280) are included to support strand 1. An output multiplexer (290) selects one of four instructions or instruction bundles to be forwarded to an instruction decode unit, e.g., instruction decode unit (120) shown in FIG. 2.

The instruction buffer (210, 250) maintains a write pointer and a read pointer. The write pointer indicates a memory location to store an incoming instruction(s) from an instruction cache. The read pointer indicates a memory location to be output from the instruction buffer on lines (215, 255).

The instruction buffer (210, 250) has a limited number of memory locations. Accordingly, a limited number of instructions are available to be output from the instruction buffer on lines (215, 255). A larger number of instructions are typically available from the instruction cache. If an instruction(s) is not available from the instruction buffer (210, 250), the instruction(s) may be fetched from the instruction cache. The multiplexer (230, 270) select whether an instruction(s) is forwarded from the instruction buffer (210, 250) or the instruction cache. The forwarded instruction(s) from the multiplexer (230, 270) is output on lines (235, 275), respectively.

The instruction(s) on lines (235, 275) is received by both the bypass buffer (240, 280) and the output multiplexer (290). The bypass buffer (240, 280) provides temporary storage for at least one instruction or a bundle of instructions. The bypass buffer (240, 280) may store the last instruction from a first strand before a switch is made to a second strand. If a strand switch occurs, the output multiplexer (290) outputs an instruction(s) selected from one of the instruction(s) in the bypass buffer (240), the instruction(s) in the bypass buffer (280), the instruction(s) forwarded from the multiplexer (230), or the instruction(s) forwarded from the multiplexer (270).

The output mulitplexer (290) outputs instruction(s) selected from one of the instruction(s) input on lines (233, 235, 273, 275). Four control signals (S1, B1, S0, B0) (not shown) control which instruction(s) input on lines (233, 235, 273, 275) is output from the output mulitplexer (290). The output mulitplexer (290) selects the output instruction(s) according to the following table:

| S1 | B1 | S0 | B0 | OUTPUT |
|---|---|---|---|---|
| 1 | 0 | 1 | 1 | Lines (233) |
| 1 | 0 | 1 | 0 | Lines (233) |
| 1 | 0 | 0 | 0 | Lines (235) |
| 1 | 1 | 1 | 0 | Lines (273) |
| 0 | 0 | 1 | 0 | Lines (275) |

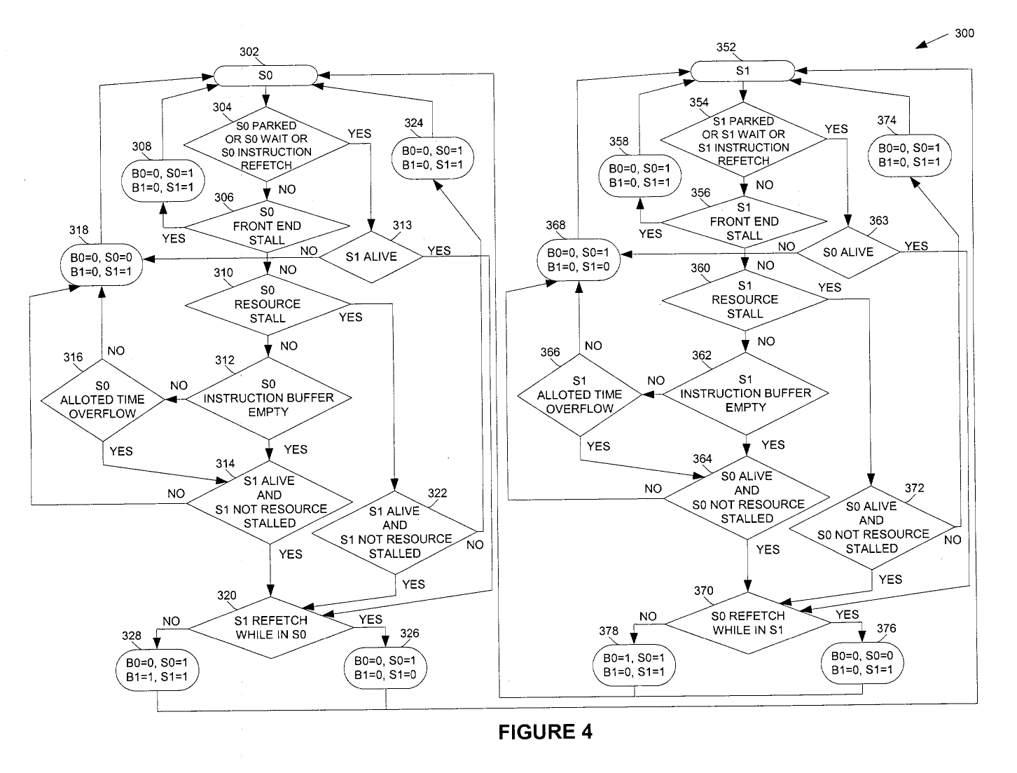

FIG. 4 shows a flow diagram of an exemplary strand switching algorithm (300) in accordance with an embodiment of the present invention. Two strands are used for the exemplary strand switching algorithm (300). A larger number of strands may also be used.

In this embodiment, during power-on one of the strands is allowed to proceed until a decision is made to switch to the other strand. For example, if strand 0 (S0) is allowed to proceed, then an instruction(s) from strand 0 (S0) enters D1 (302). In some embodiments, the instruction(s) may be part of a bundle of instructions. A determination is made as to whether strand 0 is in a parked state or a wait state, or has caused an instruction refetch (304). An instruction refetch, also referred to as a refetch, may occur if a branch misprediction or trap occurs. If strand 0 is not in a parked state or a wait state, or has not caused an instruction refetch, a determination is made as to whether a front end stall for strand 0 has occurred (306). If strand 0 is in a parked or a wait state, or has caused an instruction refetch, a determination is made as to whether strand 1 is alive (313). A strand is alive if a computer system pipeline has instructions for the strand, and the strand is not in a parked or wait state. A parked state or a wait state is a temporary stall of a strand. A parked state is initiated by an operating system, whereas a wait state is initiated by program code.

If a front end stall for strand 0 has not occurred, a determination is made as to whether a resource stall for strand 0 has occurred (310). If a front end stall for strand 0 has occurred, control registers (S1/B1/S0/B0=1/0/1/0) are set (308) and strand 0 is continued (302). If strand 0 does not have a resource stall, a determination is made as to whether an instruction buffer for strand 0 is empty (312). If strand 0 does have a resource stall, a determination is made as to whether strand 1 is alive and strand 1 is not in a resource stall (322).

If an instruction buffer for strand 0 is not empty, a determination is made as to whether a value of a counter (e.g., counter (125) shown in FIG. 2) has reached a particular count (316). If an instruction buffer for strand 0 is empty, a determination is made as to whether strand 1 is alive and strand 1 is not in a resource stall (314). If a value of a counter has not reached a particular count, control registers (S1/B1/S0/B0=1/0/0/0) are set (318) and strand 0 is continued (302). If a value of a counter has reached a particular count, a determination is made as to whether strand 1 is alive and strand 1 is not in a resource stall (314).

If strand 1 is not alive or strand 1 is in a resource stall (314), control registers (S1/B1/S0/B0=1/0/0/0) are set (318) and strand 0 is continued (302). If strand 1 is alive and strand 1 is not in a resource stall (314), a determination is made as to whether an instruction refetch for strand 1 while in strand 0 occurred (320). If strand 1 is not alive or strand 1 is in a resource stall (322), control registers (S1/B1/S0/B0=1/0/1/0) are set (324) and strand 0 is continued (302). If strand 1 is alive and strand 1 is not in a resource stall (322), a determination is made as to whether an instruction refetch for strand 1 while in strand 0 occurred (320).

If strand 1 is not alive (313), control registers (S1/B1/S0/B0=1/0/0/0) are set (318) and strand 0 is continued (302). If strand 1 is alive (313), a determination is made as to whether an instruction refetch for strand 1 while in strand 0 occurred (320).

If an instruction refetch for strand 1 while in strand 0 occurred, control registers (S1/B1/S0/B0=0/0/1/0) are set (326) and a switch to strand 1 occurs (352). If no instruction refetch for strand 1 while in strand 0 occurred, control registers (S1/B1/S0/B0=1/1/1/0) are set (328) and a switch to strand 1 occurs (352).

An instruction(s) from strand 1 enters D1 (352). The instruction(s) may be part of a bundle of instructions. A determination is made as to whether strand 1 is in a parked state or a wait state, or has caused an instruction refetch (354). If strand 1 is not in a parked state or a wait state, or has not caused an instruction refetch, a determination is made as to whether a front end stall for strand 1 has occurred (356). If strand 1 is in a parked or a wait state, or has caused an instruction refetch, a determination is made as to whether strand 0 is alive (363).

If a front end stall for strand 1 has not occurred, a determination is made as to whether a resource stall for strand 1 has occurred (360). If a front end stall for strand 1 has occurred, control registers (S1/B1/S0/B0=1/0/1/0) are set (358) and strand 1 is continued (352). If strand 1 does not have a resource stall, a determination is made as to whether an instruction buffer for strand 1 is empty (362). If strand 1 does have a resource stall, a determination is made as to whether strand 0 is alive and strand 0 is not in a resource stall (372).

If an instruction buffer for strand 1 is not empty, a determination is made as to whether a value of a counter (e.g., counter (125) shown in FIG. 2) has reached a particular count (366). If an instruction buffer for strand 1 is empty, a determination is made as to whether strand 0 is alive and strand 0 is not in a resource stall (364). If a value of a counter has not reached a particular count, control registers (S1/B1/S0/B0=0/0/1/0) are set (368) and strand 1 is continued (352). If a value of a counter has reached a particular count, a determination is made as to whether strand 0 is alive and strand 0 is not in a resource stall (364).

If strand 0 is not alive or strand 0 is in a resource stall (364), control registers (S1/B1/S0/B0=0/0/1/0) are set (368) and strand 1 is continued (352). If strand 0 is alive and strand 0 is not in a resource stall (364), a determination is made as to whether an instruction refetch for strand 0 while in strand 1 occurred (370). If strand 0 is not alive or strand 0 is in a resource stall (372), control registers (S1/B1/S0/B0=1/0/1/0) are set (374) and strand 0 is continued (352). If strand 0 is alive and strand 0 is not in a resource stall (372), a determination is made as to whether an instruction refetch for strand 0 while in strand 1 occurred (370).

If strand 0 is not alive (363), control registers (S1/B1/S0/B0=0/0/1/0) are set (368) and strand 1 is continued (352). If strand 0 is alive (313), a determination is made as to whether an instruction refetch for strand 0 while in strand 1 occurred (370).

If an instruction refetch for strand 0 while in strand 1 occurred, control registers (S1/B1/S0/B0=1/0/0/0) are set (376) and a switch to strand 0 occurs (302). If no instruction refetch for strand 0 while in strand 1 occurred, control registers (S1/B1/S0/B0=1/0/1/1) are set (378) and a switch to strand 0 occurs (302).

One of ordinary skill in the art will understand that the strand switching algorithm (300) may include additional or fewer decisions as to whether a switch to another strand should occur.

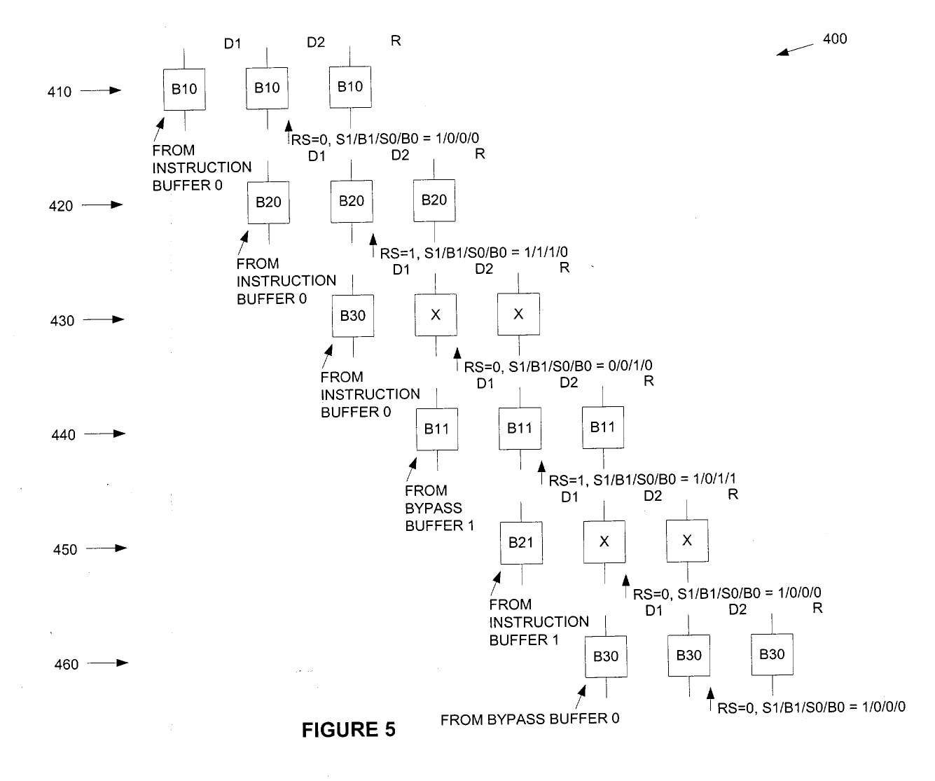

FIG. 5 shows an exemplary strand switching pipeline diagram (400) in accordance with an embodiment of the present invention. A pipeline diagram displays instructions at different stages in a pipeline at different times or clock cycles. Each horizontal line displays a single instruction or bundle of instructions as the single instruction or bundle of instructions progresses from one stage to another stage in the pipeline. For example in FIG. 5, a bundle of instructions for strand 0 (B10) enters (410) a first instruction decode stage (D1). At a next time increment, the bundle of instructions for strand 0 (B10) enters (410) a second instruction decode unit (D2) and a second bundle of instructions for strand 0 (B20) enters (420) the first instruction decode stage (D1). At a next time increment, the bundle of instructions for strand 0 (B10) enters (410) a rename and issue unit (R), a second bundle of instructions for strand 0 (B20) enters (420) the second instruction decode unit (D2), and a third bundle of instructions for strand 0 (B30) enters (430) the first instruction decode stage (D1).

Two strands are represented in the pipeline diagram (400). Each bundle of instructions uses a first number to represent a bundle number. The bundles are numbered consecutively for each strand. A second number in the bundle of instructions represents one of two strands. For example, “B10” represents a first bundle of instructions for strand 0. For example, “B21” represents a second bundle of instructions for strand 1.

A resource stall (RS) is checked at a beginning of processing in the second decode stage (D2). If a resource stall occurs for a current strand (RS=1) and the other strand does not have a resource stall and is alive, the second decode stage (D2) switches strands. For example, the third bundle of instructions for strand 0 (B30) is applied (430) to the first decode stage (D1); however, a resource stall occurs (RS=1) at the beginning of processing (420) in the second decode stage (D2) for the third bundle of instructions for strand 0 (B30). Accordingly, the third bundle of instructions for strand 0 (B30) does not enter (430) the second decode stage (D2). A bubble in the pipeline occurs (430) as indicated by “X.”

As a result of the resource stall (420), a first bundle of instructions for strand 1 (B11) enters (440) the first decode stage (D1). A resource stall occurred (RS=1) at the beginning of processing in the second decode stage (D2) for the second bundle of instructions for strand 1 (B21). Accordingly, the second bundle of instructions for strand 1 (B21) does not enter (450) the second decode stage (D2). A bubble in the pipeline occurs (450) as indicated by “X.” As a result of the resource stall (440), the third bundle of instructions for strand 0 (B30) is refetched (460) and enters the first decode stage (D1).

The first bundle of instructions for strand 1 (B11) enters (440) the first decode stage (D1) from a bypass buffer for strand 1, e.g., the bypass buffer for strand 1 (280) shown in FIG. 3. The first bundle of instructions for strand 1 (B11) was selected because a resource stall occurred (420) at the beginning of processing in second decode stage (D2) for the second bundle of instructions for strand 0 (B20). Accordingly, the second bundle of instructions for strand 1 (B21) enters (450) the first decode stage (D1) from an instruction buffer for strand 1, e.g., the instruction buffer for strand 1 (250) shown in FIG. 3. The second bundle of instructions for strand 1 (B21) was selected (430) at the beginning of processing in first decode stage (D1) for the first bundle of instructions for strand 1 (B11).

The third bundle of instructions for strand 0 (B30) enters (460) the first decode stage (D1) from a bypass buffer for strand 0, e.g., the bypass buffer for strand 0 (240) shown in FIG. 3. The third bundle of instructions for strand 0 (B30) was selected because a resource stall occurred (440) at the beginning of processing in second decode stage (D2) for the first bundle of instructions for strand 1 (B11). The third bundle of instructions for strand 0 (B30) was loaded into the bypass buffer when the third bundle of instructions for strand 0 (B30) was forwarded (430) to the first decode stage (D1) by an instruction fetch unit, e.g., the instruction fetch unit (200) shown in FIG. 3.

One of ordinary skill in the art will understand that a pipeline may have many stages that may include the stages shown in FIG. 5 A pipeline may have different stages than the stages shown in FIG. 5 A bundle may include one or more instructions. The instructions in the bundle may be processed out of order. Two or more strands may be supported by the pipeline. A resource stall may be indicated when a few resources are still available, but the resources may not be sufficient and/or advantageous to continue processing the current strand.

Advantages of the present invention may include one or more of the following. In one or more embodiments, a plurality of strands may be processed such that a processor may continue to perform useful operations even if one strand incurs a long latency event.

In one or more embodiments, one of a plurality of strands may be processed by a processor at any given time. A switch from one strand to another strand does not require a long latency to perform an instruction refetch. A bypass buffer for each strand provides temporary storage for an instruction or bundle of instructions such that the instruction or bundle of instructions is readily available to be forwarded to a next stage in a pipeline.

In one or more embodiments, a decode unit is arranged to switch strands and to indicate which instruction or bundle of instructions should be forwarded to the decode unit. An instruction fetch unit is arranged to fetch instructions from a bypass buffer, an instruction buffer, and/or an instruction cache.

In one or more embodiments, a computer system pipeline may be arranged to operate on a plurality of strands such that resources are available to support switching between the plurality of strands.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus, comprising:
an instruction fetch unit arranged to receive a plurality of instructions, the instruction fetch unit comprising:
a first bypass buffer arranged to receive at least a first portion of the plurality of instructions, and
an output multiplexer arranged to receive the at least a first portion of the plurality of instructions, wherein the output multiplexer is arranged to output an instruction selected from one of an output of the first bypass buffer and the at least a first portion of the plurality of instructions;
a decode unit operatively connected to the instruction fetch unit and arranged to decode the instruction; and
an execution unit operatively connected to the decode unit and arranged to process data dependent on the instruction.

2. The apparatus of claim 1, further comprising:
an instruction cache operatively connected to the instruction fetch unit and arranged to store the plurality of instructions.

3. The apparatus of claim 2, the instruction fetch unit further comprising:
a first instruction buffer arranged to receive the plurality of instructions from the instruction cache.

4. The apparatus of claim 3, wherein the first instruction buffer receives the plurality of instructions from a first strand.

5. The apparatus of claim 3, the instruction fetch unit further comprising:
a first multiplexer arranged to receive the plurality of instructions from the instruction cache, wherein the first multiplexer is arranged to output the at least a first portion of the plurality of instructions selected from one of an output of the first instruction buffer and the plurality of instructions.

6. The apparatus of claim 2, the instruction fetch unit further comprising:
a second bypass buffer arranged to receive at least a second portion of the plurality of instructions, wherein the output multiplexer is further arranged to receive the at least a second portion of the plurality of instructions, and
wherein the output multiplexer is arranged to output the instruction selected from one of the output of the first bypass buffer, an output of the second bypass buffer, the at least a first portion of the plurality of instructions, and the at least a second portion of the plurality of instructions.

7. The apparatus of claim 6, wherein the first bypass buffer receives the at least a first portion of the plurality of instructions from a first strand, and
wherein the second bypass buffer receives the at least a second portion of the plurality of instructions from a second strand.

8. The apparatus of claim 6, the instruction fetch unit further comprising:
a second instruction buffer arranged to receive the plurality of instructions from the instruction cache.

9. The apparatus of claim 8, wherein the second instruction buffer receives the plurality of instructions from a second strand.

10. The apparatus of claim 8, the instruction fetch unit further comprising:
a second multiplexer arranged to receive the plurality of instructions from the instruction cache,
wherein the second multiplexer is arranged to output the at least a second portion of the plurality of instructions selected from one of an output of the second instruction buffer and the plurality of instructions.

11. A method for processing a plurality of instructions, comprising:
propagating at least a first portion of the plurality of instructions;
buffering the at least a first portion of the plurality of instructions;
selectively propagating an instruction selected from one of an output of the first bypass buffer and the at least a first portion of the plurality of instructions;
decoding the instruction; and
executing the instruction.

12. The method of claim 11, further comprising:
storing the plurality of instructions.

13. The method of claim 11, further comprising:
buffering the plurality of instructions using a first instruction buffer.

14. The method of claim 13, further comprising:
selectively propagating the at least a first portion of the plurality of instructions selected from one of an output of the first instruction buffer and the plurality of instructions.

15. The method of claim 11, further comprising:
propagating at least a second portion of the plurality of instructions; and
buffering the at least the second portion of the plurality of instructions using a second bypass buffer, wherein the selectively propagating further comprises selectively propagating the instruction selected from one of the output of the first bypass buffer, the at least a first portion of the plurality of instructions, an output of the second bypass buffer, and the at least a second portion of the plurality of instructions.

16. The method of claim 11, further comprising:
buffering the plurality of instructions using a second instruction buffer.

17. The method of claim 16, further comprising:
selectively propagating the at least the second portion of the plurality of instructions selected from one of an output of the second instruction buffer and the plurality of instructions.

18. A method to process instructions, comprising:
fetching a first strand, wherein the first strand comprises instructions from a first process;
fetching a second strand, wherein the second strand comprises instructions from a second process; and
selectively switching from the first strand to the second strand dependent on whether an instruction refetch for the second strand has occurred.

19. The method of claim 18, wherein the selectively switching is further dependent on whether the second strand is alive and the second strand is not resource stalled.

20. The method of claim 18, wherein the selectively switching is further dependent on whether an instruction buffer for the first strand is empty.

21. The method of claim 18, wherein the selectively switching is further dependent on whether a resource stall for the first strand has occurred.

22. The method of claim 18, wherein the selectively switching is further dependent on whether a front end stall for the first strand has occurred.

23. The method of claim 18, wherein the selectively switching is further dependent on whether the first strand is parked.

24. The method of claim 18, wherein the selectively switching is further dependent on whether the first strand is in a wait state.

25. The method of claim 18, wherein the selectively switching is further dependent on whether an instruction refetch for the first strand has occurred.

26. The method of claim 18, wherein the selectively switching is further dependent on whether the second strand is alive.

27. The method of claim 18, wherein the selectively switching is further dependent on whether a value of a counter has reached a particular count.

28. An apparatus, comprising:
means for propagating at least a first portion of a plurality of instructions;
means for propagating at least a second portion of the plurality of instructions;
means for buffering the at least a first portion of the plurality of instructions, wherein the means for buffering outputs a buffered first portion of the plurality of instructions;
means for buffering the at least a second portion of the plurality of instructions, wherein the means for buffering outputs a buffered second portion of the plurality of instructions; and
means for selectively propagating an instruction selected from one of the at least a first portion of the plurality of instructions, the at least a second portion of the plurality of instructions, the buffered first portion of the plurality of instructions, and the buffered second portion of the plurality of instructions.
